(19) United States
(12) Patent Application Publication
(10) Pub. No.: US 2023/0394473 A1
(43) Pub. Date: Dec. 7, 2023

(54) Authenticating Users and Controlling Access to Secure Information Systems Via Linked Devices

(71) Applicant: Bank of America Corporation, Charlotte, NC (US)

(72) Inventors: Geoffrey George Aslaksen, Matthews, NC (US); Neal Aaron Slensker, Fort Mill, SC (US); Anusha Addagudi, Centennial, CO (US); Matthew Aaron Whitehurst, Indian Land, SC (US); Vanesa Mitrevski, Indian Head Park, IL (US); Srinivasa Gadiparthy, Frisco, TX (US); Lynda Finn, Fort Mill, SC (US); James Gasper Mathias, Charlotte, NC (US)

(21) Appl. No.: 17/831,693

(22) Filed: Jun. 3, 2022

(51) Int. Cl. G06Q 20/38; G06Q 20/40

(52) U.S. Cl. CPC G06Q 20/382; G06Q 20/401

(57) ABSTRACT

Arrangements for controlling transaction processing via linked devices are provided. In some aspects, customer linking data may be received from a user. For instance, a user may identify one or more user computing devices, as well as one or more payment devices, such as credit cards, debit cards, and the like. The customer linking data may include an indication to link the user computing devices to the payment devices in order to execute one or more rules limiting transaction processing associated with the payment devices. A request to process a transaction and transaction details may be received from an external entity computing system. The request for transaction and transaction details may be analyzed to determine whether the user computing device is linked to the payment device. If so, the transaction may be authorized and processed. If not, additional authentication data may be requested.

### BACKGROUND

Aspects of the disclosure relate to electrical computers, systems, and devices for providing authentication functions and controlling access to secure systems based on linked hardware devices.

Unauthorized use of payment devices, such as credit cards, debit cards, and the like, is an ongoing issue for both consumers and enterprise organizations, such as financial institutions, payment processing entities, and the. If an unauthorized actor gains access to a payment device number, the actor may freely use that device to make online purchases (e.g., until the card is reported missing, unauthorized activity is detected, or the like). Accordingly, it would be advantageous to link payment devices to one or more hardware devices in order to limit use of the payment device to transactions made via the linked hardware devices.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with controlling use of payment devices and avoiding unauthorized use of payment devices.

In some aspects, customer linking data including registration data may be received from a user. For instance, a user may identify one or more user computing devices (e.g., hardware devices such as smartphones, wearable devices, laptop computers, desktop computers, tablets and the like), as well as one or more payment devices, such as credit cards, debit cards, and the like. The customer linking data may include an indication to link the user computing devices to the payment devices in order to execute one or more rules limiting transaction processing associated with the payment devices.

In some examples, a request to process a transaction may be received from, for instance, an external entity computing system. The request may include transaction details including an identifier of the user computing device initiating the transaction, a payment device being used, and the like. The request for transaction and transaction details may be analyzed to determine whether the user computing device is linked to the payment device. If so, the transaction may be authorized and processed. If not, additional authentication data may be requested.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing device linking functions in accordance with one or more aspects described herein;

FIGS. 2A-2H depict an illustrative event sequence for implementing device linking functions in accordance with one or more aspects described herein;

FIG. 3 illustrates an illustrative method for implementing device linking functions according to one or more aspects described herein;

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, unauthorized use of payment devices, such as debit cards, credit cards, and the like, is an ongoing issue. In some examples, unauthorized actors may complete online purchases using the payment card information, which may be costly to both consumers and enterprise organizations. Accordingly, aspects described herein are related to providing additional security by limiting transaction processing with payment devices to linked hardware devices, including various user computing devices.

For instance, a user or family may have a plurality of user computing devices that is uses weekly, daily, or the like, to complete online transactions. For example, a family of three might have three smartphones, two smart watches, two tablets and a laptop. Accordingly, a user may register the three smartphones, two smart watches, two tablets and laptop with the device linking computing platform as being linked to the one or more payment devices (e.g., credit cards, debit cards, and the like) associated with the family. Accordingly, if the example family has 4 credit cards and two debit cards, the 4 credit cards and 2 debit cards may be linked to each of the user computing devices during a registration process. In some examples, all payment devices might not be linked to all user computing devices. However, once a user computing device is linked to a payment device, transactions may be processed via the user computing device using the linked payment device without additional authentication or authorization from the user. Accordingly, if an attempt is made to complete a purchase using the payment device from a non-linked computing device (e.g., device of an unauthorized user) additional authentication and/or authorization may be required in order to process the transaction. Accordingly, this may reduce or eliminate unauthorized use of payment devices for registered user with respect to, for instance, online purchases.

Once the user computing devices and payment devices are linked, when a request to process a transaction is received, the system may determine (e.g., based on a unique hardware identifier of the user computing device initiating the transaction) whether the user computing device is linked to the payment device being used. If so, the transaction may be authorized. If not, a request for authentication data may be generated and transmitted.

These and various other arrangements will be discussed more fully below.

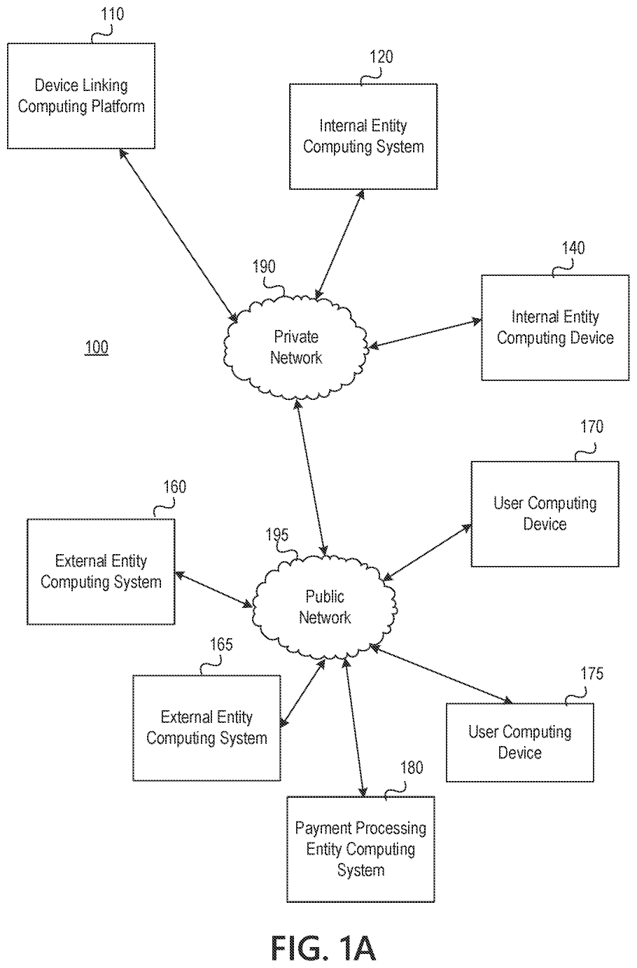

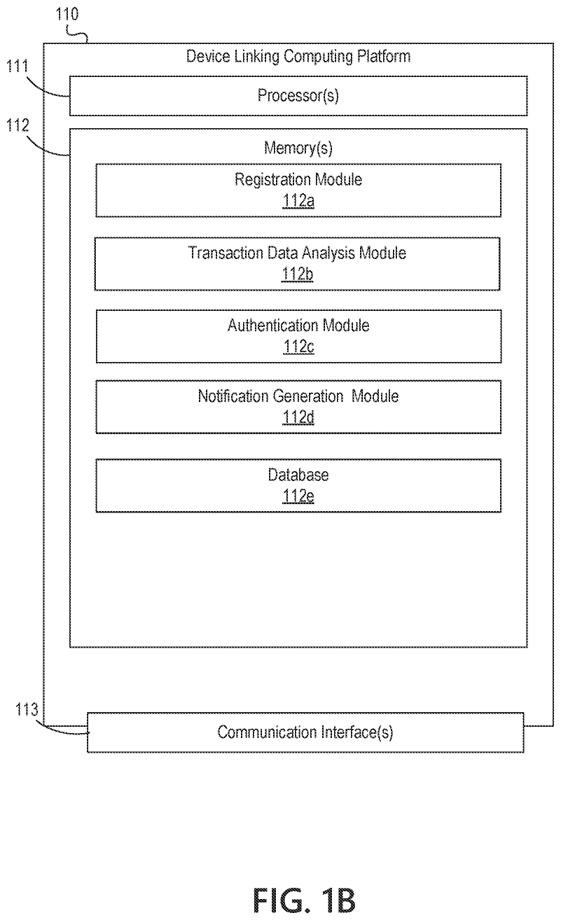

FIGS. 1A-1B depict an illustrative computing environment for implementing trusted device linking and control functions in accordance with one or more aspects described herein. Referring to FIG. 1A, computing environment 100 may include one or more computing devices and/or other computing systems. For example, computing environment 100 may include device linking computing platform 110, internal entity computing system 120, internal entity computing device 140, external entity computing system 160, external entity computing system 165, user computing device 170, user computing device 175, and payment processing entity computing system 180. Although one internal entity computing system 120, one internal entity computing device 140, two external entity computing systems 160, 165, two user computing devices 170, 175, and one payment processing entity computing system 180, any number of systems or devices may be used without departing from the invention.

Device linking computing platform 110 may be configured to perform intelligent, dynamic and efficient registration of user computing devices and associated payment devices (e.g., credit cards, debit cards, or the like), and authenticate users and authorize transactions based on the linking of the user computing devices with the associated payment devices. For instance, device linking computing platform 110 may receive registration data from one or more user computing devices, such as smartphones, smart watches, laptop computers, desktop computers, tablet computers, and the like. In some examples, the registration data may include a unique identifier associated with each device, such as a unique device identifier (UDID), international mobile equipment identity (IMEI), globally unique identifier (GUID), or the like. In some examples, registration data for user computing devices for a single user may be received. Additionally or alternatively, registration data for devices for a plurality of associated users (e.g., members of a family, members of a business unit within an organization, and the like) may be received.

The device linking computing platform 110 may further receive payment device identification data. For instance, one or more debit card, credit card, or the like, associated with the registered user and/or additional users may be received. The payment device identification data may include an account number, expiration data, card verification value (CVV), or the like, may be received. The received payment device data may then be linked to each registered user computing device and the linkage may be stored in, for instance, a database of the device linking computing platform 110.

When a user requests a transaction (e.g., makes an online purchase), the user may input a desired payment device as a mode of payment when attempting to complete the transaction. This data may be transmitted (e.g., via the external entity computing system with which the transaction is being made) to the device linking computing platform 110. Further, a unique identifier associated with the user computing device from which the request transaction was received, may be transmitted to and received by the device linking computing platform 110. The payment card information and user computing device information may be analyzed to determine whether the payment card identified is linked to the user computing device identified. If so, the user may be authenticated and the transaction may be authorized (e.g., without any additional user input, authentication data, approval or the like). Alternatively, if the payment device is not linked to the user computing device (e.g., if the user is making a transaction from a user computing device associated with another person that is not linked to the payment device, from a new, unregistered device, or the like), the system may generate a request for authentication data, authorization, and the like, and may transmit that request to the user computing device. In some examples, if the payment device is not linked to the user computing device requesting the transaction, the transaction may be denied.

In some examples, during registration, a user may customize various options. For instance, the user may customize a type or number of factors of authentication required if the payment device is not linked to the user computing device. In another example, the user may customize ways that authorization may be provided (e.g., via second device, or the like).

Internal entity computing system 120 may be or include one or more computing devices (e.g., servers, server blades, or the like) that may host or execute one or more applications associated with the enterprise organization. For instance, internal entity computing system 120 may host or execute one or more account update applications that may maintain an account ledger and modify a balance of a user account upon processing a transaction. Additionally or alternatively, internal entity computing system 120 may host or execute one or more applications maintaining user data, user account data, user payment device data, and the like.

Internal entity computing device 140 may be or include one or more computing devices, such as laptop computers, desktop computers, smartphones, tablets, or the like, and may be operated by one or more employees of the enterprise organization to modify rules associated with the device linking computing platform 110.

External entity computing system 160 and external entity computing system 165 may be or include one or more computing devices or systems (e.g., servers, server blades, or the like) that may host or execute one or more applications providing transaction processing services for one or more entities. For instance, external entity computing system 160 and/or external entity computing system 165 may be or include one or more vendor computing systems configured to process transactions (e.g., online transaction, mobile device transactions, or the like).

User computing device 170 and/or user computing device 175 may be or include a computing device, such as a laptop, desktop, smartphone, smart watch, tablet device, or the like, that may be associated with a user (e.g., customer) requesting the transaction. In some examples, user computing device 170 and/or user computing device 175 may be configured to communicate with device linking computing platform 110 to provide registration data. Further, user computing device 170 and/or user computing device 175 may be configured to communicate with external entity computing system 160, external entity computing system 165, or the like, to request transaction processing (e.g., via one or more online or mobile applications, websites, or the like). User computing device 170 and user computing device 175 may be two user computing devices associated with a same user (e.g., a smartphone and a tablet) or may be devices associated with different users that are registered together and linked to payment devices (e.g., smartphones of spouses, tablet of parent and smartphone of child, or the like).

Payment processing entity computing system 180 may be or include one or more computing devices or systems (e.g., servers, server blades, or the like) and may be associated with a payment processing entity (e.g., credit card provider, or the like). In some examples, device linking data may be transmitted by the device linking computing platform 110 to the payment processing entity computing system 180 and evaluation of whether a requesting device is linked to a requesting payment device may be performed by the payment processing entity computing system 180 (e.g., in lieu of or in addition to device linking computing platform 110). In some examples, device linking computing platform 110 may authorize or instruct payment processing computing system 180 to process a requested transaction based on the user computing device being linked to the payment device. In some examples, the transaction may be authorized based only on the user computing device being linked to the payment device.

As mentioned above, computing environment 100 also may include one or more networks, which may interconnect one or more of device linking computing platform 110, internal entity computing system 120, internal entity computing device 140, external entity computing system 160, external entity computing system 165, user computing device 170, user computing device 175, and/or payment processing entity computing system 180. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, device linking computing platform 110, internal entity computing system 120, internal entity computing device 140, may be associated with an enterprise organization (e.g., a financial institution), and private network 190 may be associated with and/or operated by the organization, and may include one or more networks (e.g., LANs, WANs, virtual private networks (VPNs), or the like) that interconnect device linking computing platform 110, internal entity computing system 120, internal entity computing device 140, and one or more other computing devices and/or computer systems that are used by, operated by, and/or otherwise associated with the organization. Public network 195 may connect private network 190 and/or one or more computing devices connected thereto (e.g., device linking computing platform 110, internal entity computing system 120, internal entity computing device 140) with one or more networks and/or computing devices that are not associated with the organization. For example, external entity computing system 160, external entity computing system 165, user computing device 170, user computing device 175, and/or payment processing entity computing system 180, might not be associated with an organization that operates private network 190 (e.g., because external entity computing system 160, external entity computing system 165, user computing device 170, user computing device 175, and/or payment processing entity computing system 180 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect external entity computing system 160, external entity computing system 165, user computing device 170, user computing device 175, and/or payment processing entity computing system 180 to private network 190 and/or one or more computing devices connected thereto (e.g., device linking computing platform 110, internal entity computing system 120, internal entity computing device 140).

Referring to FIG. 1B, device linking computing platform 110 may include one or more processors 111, memory 112, and communication interface 113. A data bus may interconnect processor(s) 111, memory 112, and communication interface 113. Communication interface 113 may be a network interface configured to support communication between device linking computing platform 110 and one or more networks (e.g., private network 190, public network 195, or the like). Memory 112 may include one or more program modules having instructions that when executed by processor(s) 111 cause device linking computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of device linking computing platform 110 and/or by different computing devices that may form and/or otherwise make up device linking computing platform 110.

For example, memory 112 may have, store and/or include registration module 112a. Registration module 112a may store instructions and/or data that may cause or enable the device linking computing platform 110 to receive a registration request for user and generate a device linking record associated with the enterprise organization (e.g., stored in, for instance, database 112e). In some examples, registration module 112a may receive a request to register a user or user computing device and may generate a request for additional registration data (e.g., unique identifiers associated with all devices being registered, payment device information (e.g., debit or credit card information), and the like. Registration module 112a may then link the received user computing device data and payment device data in the device linking record (e.g., store the user computing device(s) and payment device(s) in association with each other in the device linking record stored in the database 112e. Registration module 112a may also receive authentication data from the user that may be used to authenticate the user and/or authorize a transaction requested from a user computing device that is not linked to a payment device being used for the transaction.

Device linking computing platform 110 may further have, store and/or include transaction data analysis module 112b. Transaction data analysis module 112b may store instructions and/or data that may cause or enable the device linking computing platform 110 to receive transaction details and data associated with one or more requested transactions (e.g., from external entity computing system 160, external entity computing system 165, or the like) and analyze the data. For instance, transaction data analysis module 112b may receive an identifier of a user computing device (e.g., device 170, 175, or the like) and a payment device being used for the transaction. The identifier and payment device may be analyzed by the transaction data analysis module 112b to determine whether the user computing device and payment device are linked. If so, the requested transaction may be authorized and processed. If not, additional data may be requested.

Device linking computing platform 110 may further have, store and/or include authentication module 112c. Authentication module 112c may store instructions and/or data that may cause or enable the device linking computing platform 110 to identify, based on a determination that a user computing device and a payment device are not linked, authentication or other authorization data to be requested from a user. In some examples, the data to request may include types of authentication data, number or type of devices to provide data, and the like. The data requested may be based on one or more authentication rules that may be default rules determined by the enterprise organization or may be customized rules determined by the user (e.g., during a registration process). Authentication module 112c may generate a request for data and may compare received data to pre-stored authentication data to determine whether the user is authenticated and/or whether the transaction is authorized to be processed.

Device linking computing platform 110 may further have, store and/or include notification generation module 112d. Notification generation module 112d may store instructions and/or data that may cause or enable the device linking computing platform 110 to generate one or more notifications or instructions that may be transmitted to one or more other systems or devices. For instance, notification generation module 112d may generate a notification causing processing of a requested transaction upon determining that the user computing device from which the request was received is linked to a payment device used in the transaction. The notification may be transmitted to external entity computing system 160, external entity computing system 165, payment processing entity computing system 180, or the like.

In another example, notification generation module 112d may generate a notification indicating that a transaction was processed and may transmit the notification to a user computing device, such as user computing device 170, user computing device 175, or the like.

Various other notifications may be generated without departing from the invention.

Device linking computing platform 110 may also include one or more databases, such as database 112e. Database 112e may store data linking one or more user computing devices 170, 175 to one or more payment devices (e.g., credit cards, debit cards, or the like). Various other information may be stored in database 112e without departing from the invention.

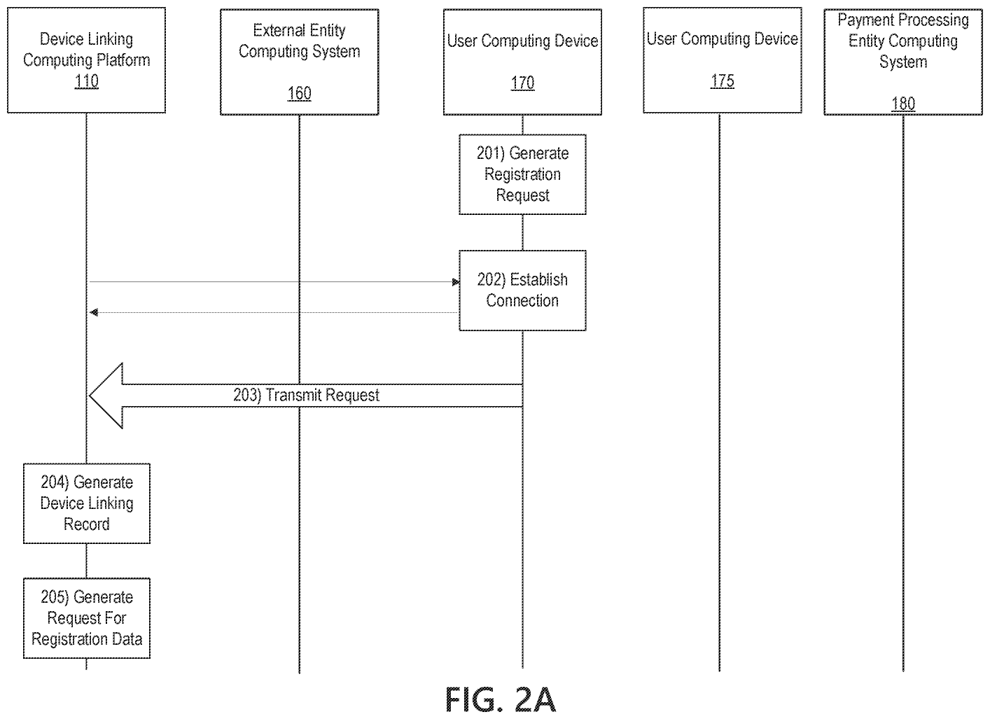

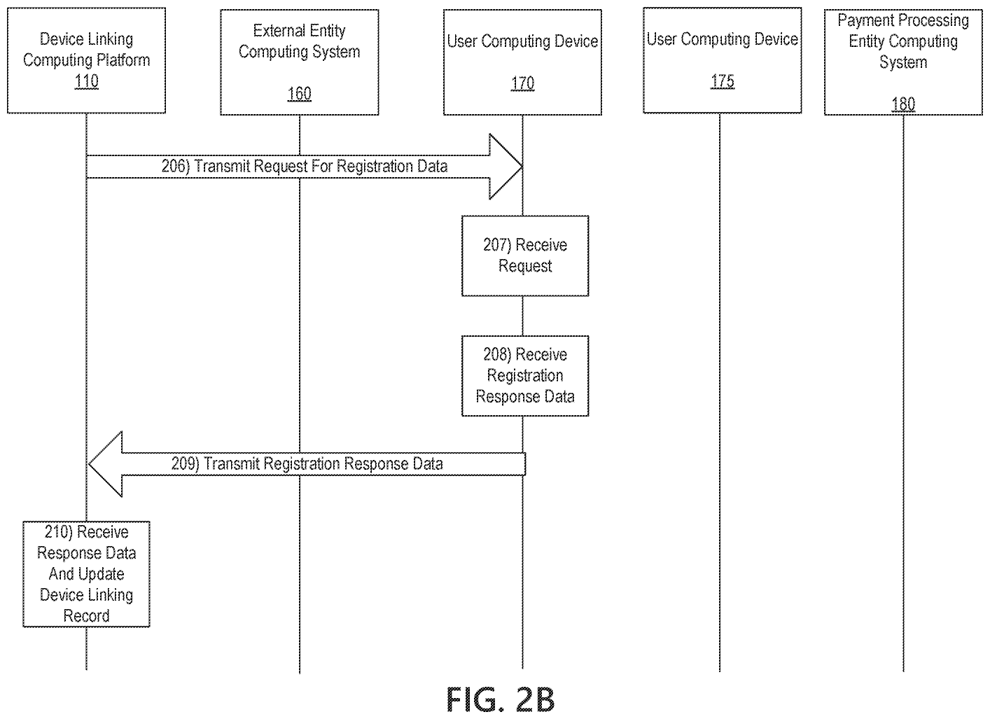

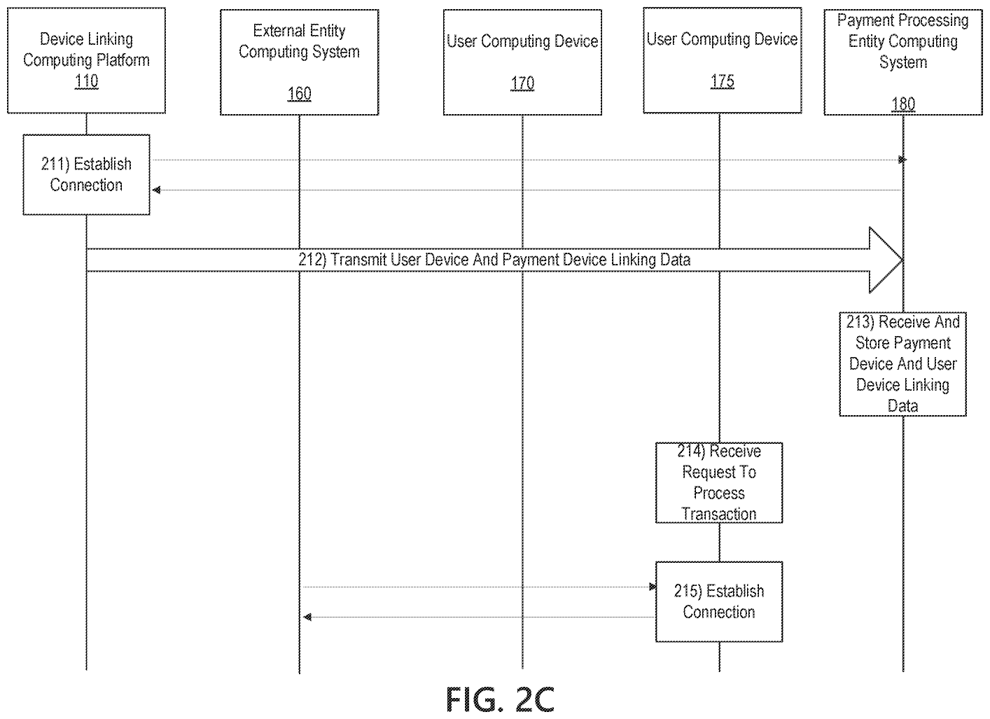

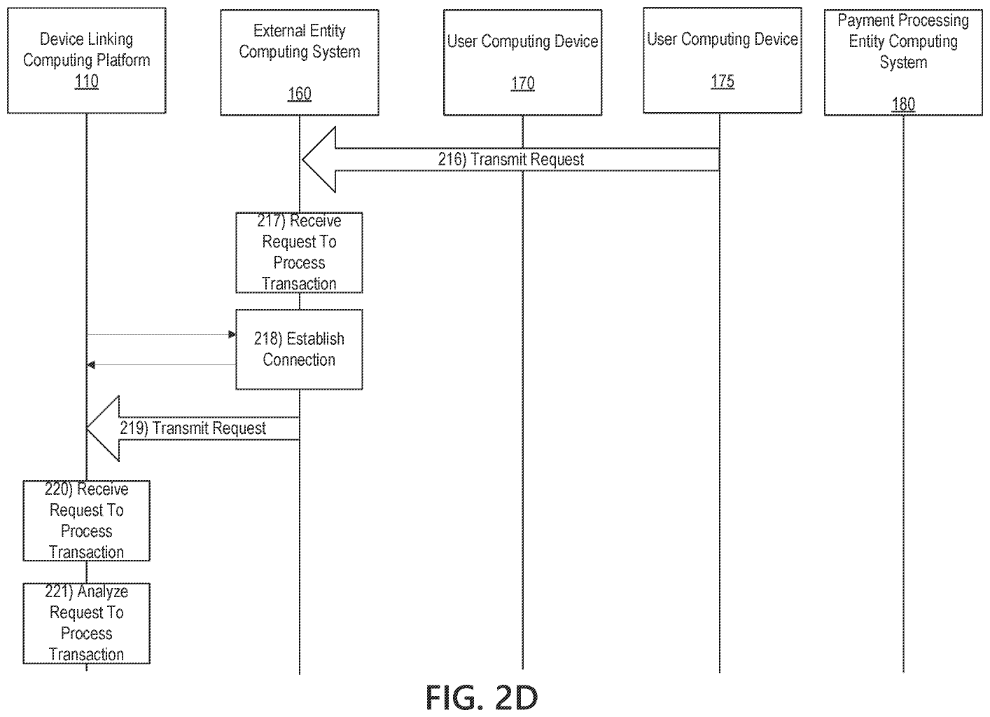

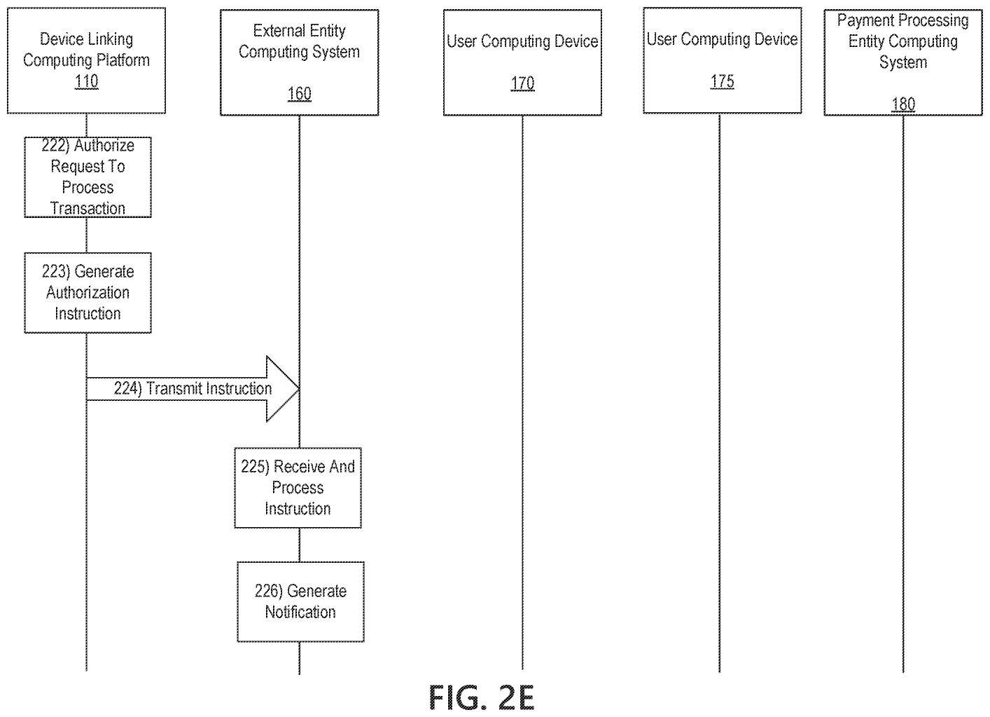

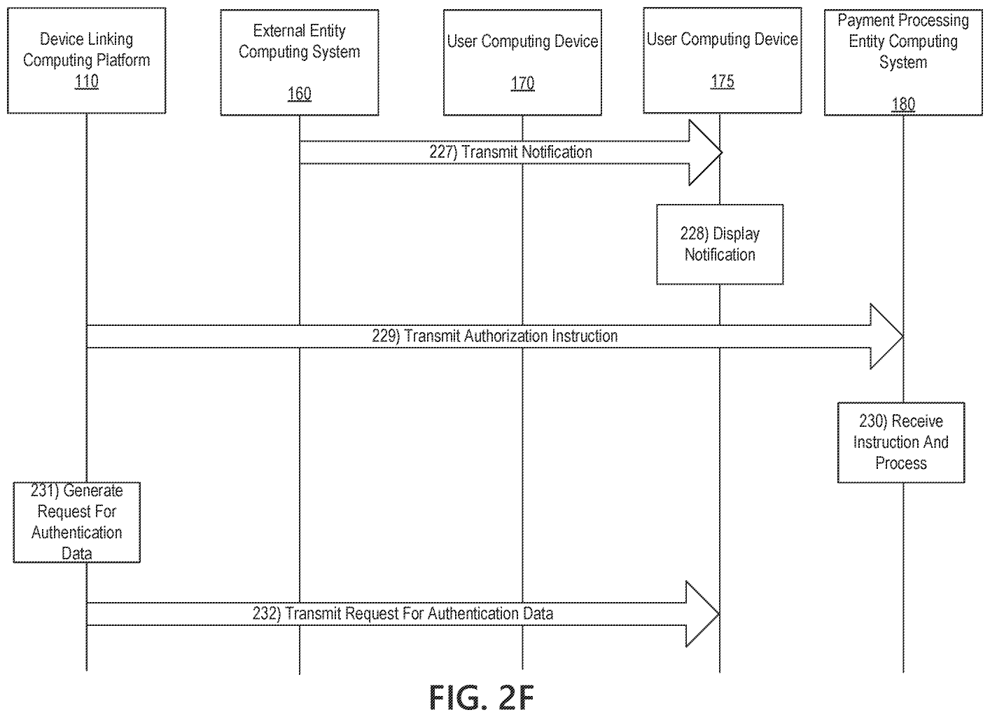

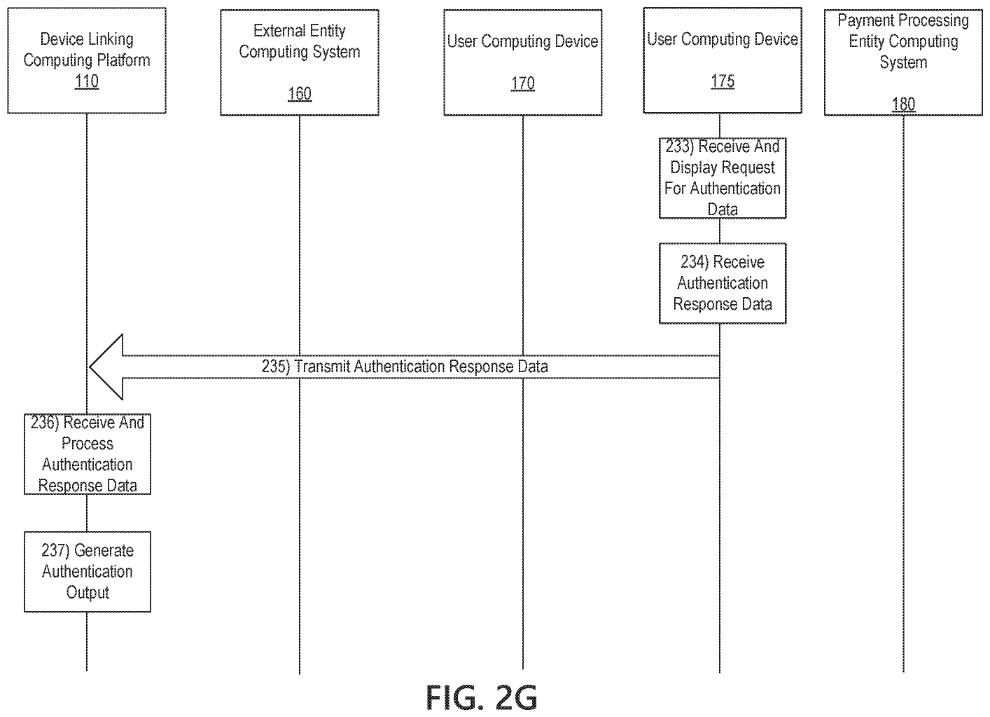

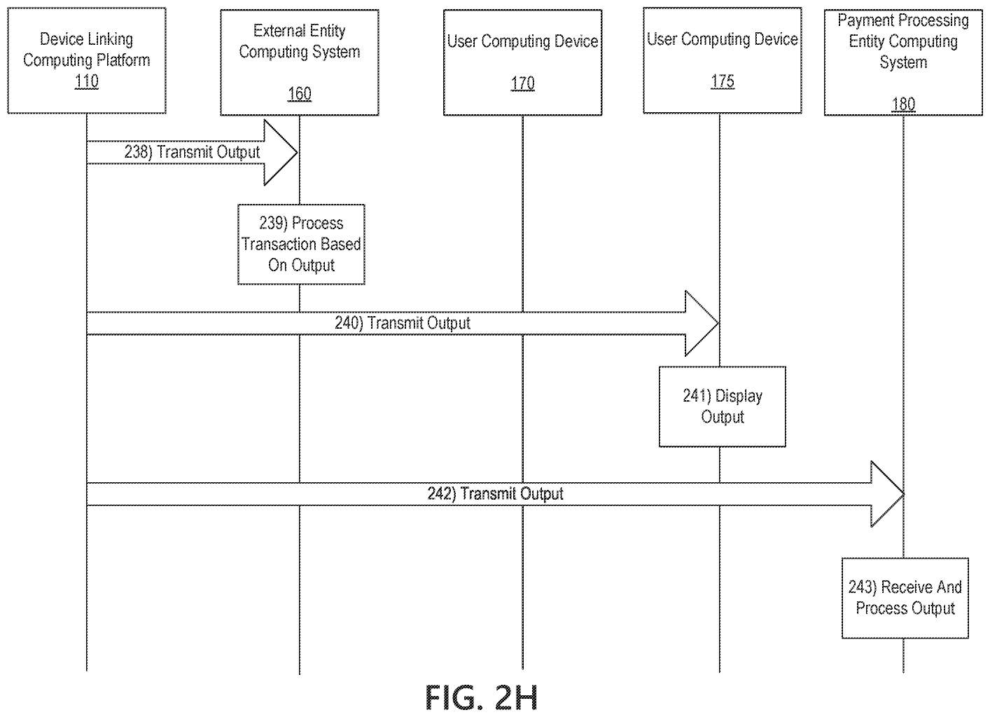

FIGS. 2A-2H depict one example illustrative event sequence for implementing device linking functions in accordance with one or more aspects described herein. The events shown in the illustrative event sequence are merely one example sequence and additional events may be added, or events may be omitted, without departing from the invention. Further, one or more processes discussed with respect to FIGS. 2A-2H may be performed in real-time or near real-time.

With reference to FIG. 2A, at step 201, a registration request may be generated by a user computing device 170. For instance, a user may input, via one or more input devices, to the user computing device 170, a request to register with the enterprise organization and the device linking computing platform 110. Accordingly, a registration request may be generated based on the user input received.

At step 202, a connection may be established between user computing device 170 and device linking computing platform 110. For instance, a first wireless connection may be established between the user computing device 170 and the device linking computing platform 110. Upon establishing the first wireless connection, a communication session may be initiated between device linking computing platform 110 and user computing device 170.

At step 203, user computing device 170 may transmit the registration request to the device linking computing platform 110. For instance, the registration request may be transmitted during the communication session initiated upon establishing the first wireless connection.

At step 204, the registration request may be received by the device linking computing platform 110 and a device linking record may be generated. For instance, one or more databases may be modified to include a record associated with the user computing device 170 from which the request was received.

At step 205, device linking computing platform 110 may generate a request for registration data. For instance, data associated with devices of the user (e.g., identifiers associated with the user computing device 170, user computing device 175, or other user computing devices, identifiers associated with the payment device(s) of the user, and the like), validation/authentication data, customization preferences, and the like, may be requested.

With reference to FIG. 2B, at step 206, the device linking computing platform 110 may transmit the request for registration data to the user computing device 170. In some examples, the request may be transmitted during the communication session initiated upon establishing the first wireless connection.

At step 207, the user computing device 170 may receive the request for registration data. In some examples, the request for registration data may be displayed on a display of the user computing device 170.

At step 208, registration response data may be received by the user computing device 170. For instance, response data including data responsive to the requests (e.g., for device identifiers, customization options, payment device information, authentication information such as biometric data, username and password, and the like) may be received (e.g., via user input, via data extraction, or the like) and registration response data may be generated.

At step 209, the registration response data may be transmitted by the user computing device 170 to the device linking computing platform 110. For instance, the response data may be transmitted during the communication session initiated upon establishing the first wireless connection or a new connection and communication session may be established and initiated.

At step 210, the registration response data may be received and stored. For instance, the device linking record associated with the user or user computing device 170 may be updated to include the received registration response data. In some examples, the registration response data may include identifiers of particular devices associated with the user, payment device data (e.g., account number, CVV, expiration date, customization options, authentication data, and the like.

With reference to FIG. 2C, at step 211, a connection may be established between device linking computing platform 110 and payment processing entity computing system 180. For instance, a second wireless connection may be established between the device linking computing platform 110 and payment processing entity computing system 180. Upon establishing the second wireless connection, a communication session may be initiated between device linking computing platform 110 and payment processing entity computing system 180.

At step 212, device linking computing platform 110 may transmit user computing device and payment device linking data to the payment processing entity computing system 180.

At step 213, payment processing entity computing system 180 may receive and store the user computing device and payment device linking data. In some examples, the payment processing entity may be configured to determine whether a requested transaction is authorized based on the stored device linking data. Additionally or alternatively, device linking computing platform 110 may determine whether the requested transaction is authorized based on user computing device and payment device linking data.

After registration data has been stored, a user may attempt to process a transaction using a payment device via a user computing device (e.g., a user may attempt, for instance, an online purchase via a user computing device and with a payment device). Accordingly, at step 214, a request to process a transaction may be received by user computing device 175. In some examples, the request to process the transaction may include a device identifier associated with the user computing device 175 from which the request was received, payment device information (e.g., account number, expiration data, CVV, or the like), and the like. In some examples, user computing device may be associated with a same user as user computing device 170 (e.g., user computing device 170 may be a smartphone of a user and user computing device 175 may be a tablet of that same user). In other examples, user computing device 175 may be associated with a different user than user computing device 170 (e.g., user computing device 170 may be a smartphone of a first user (e.g., parent, spouse, or the like) and user computing device 175 may be a smartphone of a second, different user (e.g., child, spouse, or the like)). Although examples described relate to devices owned by family members, the user computing device 170 may be associated with a first user and user computing device 175 may be associated with a second, different, user who may or might not be a family member of the first user.

At step 215, a connection may be established between user computing device 175 and external entity computing system 160. For instance, a third wireless connection may be established between the user computing device 175 and the external entity computing system 160. Upon establishing the third wireless connection, a communication session may be initiated between user computing device 175 and external entity computing system 160.

With reference to FIG. 2D, at step 216, the user computing device 175 may transmit the request to process the transaction to the external entity computing system 160. For instance, the request to process the transaction may be transmitted during the communication session initiated upon establishing the third wireless connection.

At step 217, external entity computing system 160 may receive the request to process the transaction.

At step 218, a connection may be established between external entity computing system 160 and device linking computing platform 110. For instance, a fourth wireless connection may be established between the device linking computing platform 110 and external entity computing system 160. Upon establishing the fourth wireless connection, a communication session may be initiated between device linking computing platform 110 and external entity computing system 160.

At step 219, external entity computing system 160 may transmit the request to process the transaction to the device linking computing platform 110. For instance, the request to process the transaction may be transmitted during the communication session initiated upon establishing the fourth wireless connection.

At step 220, the device linking computing platform 110 may receive the request to process the transaction.

At step 221, the device linking computing platform 110 may analyze the received request to process the transaction. For instance, the identifier associated with the user computing device 175 from which the request was received and the payment device information associated with the payment device being used to process the transaction may be analyzed to determine whether the user computing device 175 is linked to the payment device (e.g., stored in a same device linking record, or the like).

If, based on the analysis, the user computing device 175 is linked to the payment device being used, the process may proceed to step 222. If, based on the analysis, the user computing device 175 is not linked to the payment device being used, the process may proceed to step 231.

With reference to FIG. 2E, at step 222, based on the analysis, device linking computing platform 110 may determine that the user computing device 175 and payment device are linked and, based on the determination, the requested transaction may be authorized.

At step 223, device linking computing platform 110 may generate one or more authorization instructions. For instance, the one or more authorization instructions may include signals or commands that may cause one or more other computing systems to process the requested transaction.

At step 224, the device linking computing platform 110 may transmit the generated authorization instruction to the external entity computing system 160. In some examples, the instruction may be transmitted during the communication session initiated upon establishing the fourth wireless connection. Alternatively, another communication session may be initiated.

At step 225, external entity computing system 160 may receive and process the authorization instruction. For instance, external entity computing system 160 may process the requested transaction based on receiving the authorization instruction (e.g., approve a purchase, or the like).

At step 226, external entity computing system 160 may generate a notification indicating that the requested transaction was approved.

With reference to FIG. 2F, at step 227, external entity computing system 160 may transmit the generated notification to the user computing device 175. In some examples, the generated notification may be transmitted during the communication session initiated upon establishing the third wireless connection. Additionally or alternatively, a new communication session may be initiated.

At step 228, the user computing device 175 may receive and display the notification. For instance, receiving the notification may cause the user computing device 175 to display the notification on a display of the user computing device 175.

At step 229, device linking computing platform 110 may transmit the generated authorization instruction to the payment processing entity computing system 180. For instance, the instruction may be transmitted during the communication session initiated upon establishing the second wireless connection. Alternatively, a new wireless connection may be established and communication session initiated.

At step 230, payment processing entity computing system 180 may receive the instruction and process the instruction authorizing processing of the transaction (e.g., modify account balances, transmit ledger update instructions to one or more financial institutions, or the like).

At step 231, if, based on analysis of the user computing device 175 identifier and payment device information, the user computing device is not linked to the payment device, a request for authentication and/or authorization data may be generated. For instance, a request for a user to provide authentication data (e.g., username and password, personal identification number, one time passcode, biometric data, or the like) may be generated and used to authorize or deny the requested transaction when the user computing device 175 is not linked to the payment device. In some examples, the particular type of authentication data may be identified in the generated request.

At step 232, device linking computing platform 110 may transmit the generated request for authentication data to the user computing device 175.

With reference to FIG. 2G, at step 233, user computing device 175 may receive and display the request for authentication data. For instance, receiving the request for authentication data may cause the request to be displayed on a display of the user computing device 175.

At step 234, authentication response data may be received by the user computing device 175. For instance, a username and password, one time passcode, or the like may be received (e.g., via user input). In some examples, biometric data (e.g., fingerprint, voiceprint, iris scan, or the like) may be received via one or more sensors arranged in or in communication with user computing device 175.

At step 235, user computing device 175 may transmit the authentication response data to the device linking computing platform 110.

At step 236, the device linking computing platform 110 may receive and process the authentication response data. For instance, the device linking computing platform 110 may compare the authentication response data to pre-stored authentication received, e.g., during the registration process.

At step 237, based on the processing of the authentication response data, device linking computing platform 110 may generate an authentication output. For instance, if the authentication response data matches pre-stored authentication data, device linking computing platform 110 may generate an authentication output and the requested transaction may be authorized. Alternatively, if the authentication response data does not match pre-stored authentication data, an authentication output rejecting the requested transaction or requesting additional or alternative authentication data may be generated.

With reference to FIG. 2H, at step 238, device linking computing platform 110 may transmit the authentication output to external entity computing system 160. At step 239, external entity computing system 160 may receive and process the authentication output. For instance, if the authentication output indicates that the transaction is approved, external entity computing system 160 may process the transaction. If the authentication output indicates that the transaction is rejected, external entity computing system 160 may reject the requested transaction and notify the user.

At step 240, the authentication output may be transmitted to the user computing device 175. At step 241, the authentication output may be displayed by a display of the user computing device 175.

At step 242, device linking computing platform 110 may transmit the authentication output to the payment processing entity computing system 180. At step 243, the payment processing entity computing system 180 may receive and process the authentication output (e.g., process payment if the transaction is authorized). In some examples, if the authentication output is a denial of the requested transaction, an output might not be transmitted to the payment processing entity computing system 180.

Although arrangements shown describe the request to process the transaction being sent to the device linking computing platform 110 and analyzed by the device linking computing platform, in some example arrangements, the request to process the transaction may be transmitted by the external entity computing system 160 to the payment processing entity computing system 180 for analysis and decisioning.

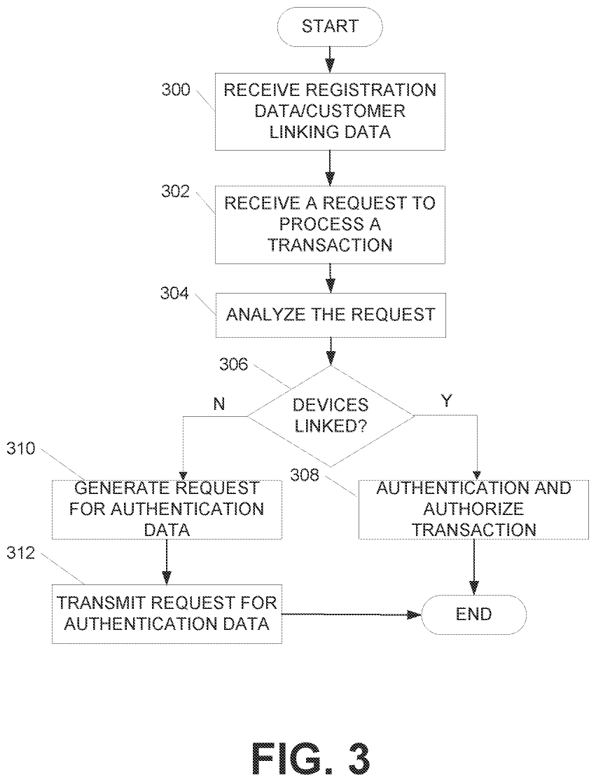

FIG. 3 is a flow chart illustrating one example method of implementing device linking functions in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, customer device linking data including registration data may be received. For instance, a user may request registration with an enterprise organization or device linking computing platform 110 via, for instance, a user computing device, such as a mobile device. In some examples, the customer device linking data including registration data may include identification of the user, identification of one or more user computing devices associated with the user or other users that the user is including in the registration (e.g., smart phones, tablets, desktop, laptops, wearable devices, or the like), identification of one or more payment devices (e.g., account numbers, expiration dates, CVV, or the like for one or more credit card, debit card, or the like), authentication data of one or more users, and the like.

In some examples, the customer device linking data may include an instruction to link the one or more user computing devices to the one or more payment devices. Linking the one or more user computing devices to the one or more payment devices may cause one or more rules limiting transaction processing for the one or more payment devices to execute. For instance, one or more rules indicating that if it is determined that a payment device being used for a transaction is linked to the user computing device from which the transaction was initiated, the user may be automatically authenticated and the transaction authorized (e.g., without additional user input) may execute. In another example, one or more rules associated with requesting authentication data from the user when it is determined that the user computing device and payment device are not linked may be executed. Additional rules may be executed without departing from the invention.

At step 302, a request to process a transaction may be received from, for instance, an entity computing device. For instance, the user may initiate an online purchase with an entity (such as an external entity) and the entity may transmit a request to process the transaction to the device linking computing platform 110. The request to process the transaction may include transaction details including a payment device being used for the transaction, an identifier of a user computing device initiating the transaction, and the like.

At step 304, the request to process the transaction and transaction details may be analyzed to determine whether the user computing device initiating the transaction with the entity computing device (e.g., based on the identifier) is linked to the payment device.

At step 306, a determination may be made, based on the analysis, of whether the user computing device is linked to the payment device. If so, the requested transaction may be authorized at step 308 (e.g., without additional user interaction or input). In some examples, authorizing the transaction may include generating and transmitting one or more authorization instructions to the entity computing device, payment processing computing system, or the like.

If, at step 306, the user computing device is not linked to the payment device, at step 310, a request for authentication data may be generated. In some examples, a type of authentication data requested may be based on the customer linking data including registration data received.

At step 312, the request for authentication data may be transmitted to the user computing device. Authentication response data may be received and analyzed to determine whether to authorize or deny the requested transaction.

Aspects described herein are related to controlling use of payment devices for online purchases based on a hardware device being used. As discussed, a user may register one or more user computing devices and link those to one or more registered payment devices. The linkage between the user computing device and payment device may then be used to determine whether a requested transaction is authenticated and/or authorized. In some examples, the determination to authorize the transaction may be based only on whether the user computing device is linked to the payment device.

Accordingly, a user, family, or the like, who may rely on just a few particular computing devices to make online purchases, may register those computing devices and any desired payment devices in order to provide additional security in online purchasing and eliminate or reduce a likelihood that unauthorized actors will successfully use payment devices for online purchases.

As discussed, if a user computing device initiating a transaction is not linked to the payment device being used, additional authentication data may be requested. In some examples, that may include biometric data (e.g., facial recognition or scan, fingerprint data, or the like) received via one or more sensors in the user computing device. Additional authentication data may be used without departing from the invention.

In some examples, registering the user computing devices and payment devices may be performed via an application associated with the enterprise organization implementing the device linking computing platform. For instance, registration data may be provided via an online or mobile banking application of a financial institution implementing the device linking computing platform 110. In addition, user computing devices and/or payment devices may be modified, added or deleted via the application.

One or more customization options may also be provided to a user registering devices. For instance, a user may select an option to require additional authentication data even if a user computing device is linked to a payment device. In some examples, this may be useful for a family with children that may have access to a parent computing device but the parent does not want the child to make purchases without permission. In some examples, a request for additional authentication data may be sent to the requesting user computing device or to another, pre-registered computing device.

Various other customizations may be selected by the user as well. For instance, if a user is traveling, the user may desire to have additional authentication required for all purchases. Additionally or alternatively, an option to be notified (e.g., on a pre-registered device that may or might not be the user computing device requesting the transaction) for all transactions may be selected. Accordingly, a user may receive a notification for any requested transaction and, in some examples, may approve or deny the transaction. Various additional customization options may be used without departing from the invention to accommodate users having varying levels of risk tolerance.

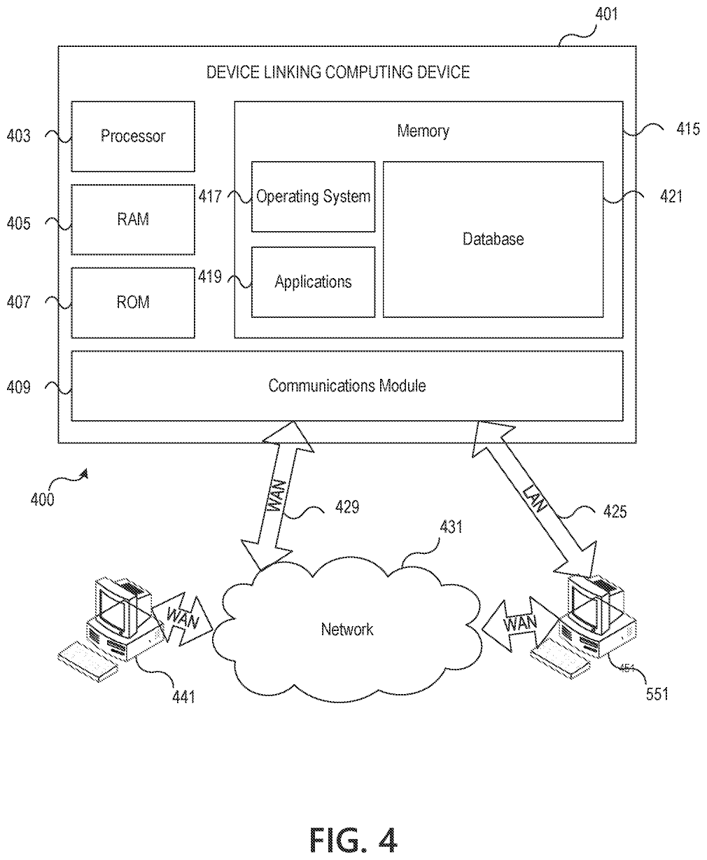

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include device linking computing device 401 having processor 403 for controlling overall operation of device linking computing device 401 and its associated components, including Random Access Memory (RAM) 405, Read-Only Memory (ROM) 407, communications module 409, and memory 415. Device linking computing device 401 may include a variety of computer readable media. Computer readable media may be any available media that may be accessed by device linking computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by device linking computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on device linking computing device 401. Such a processor may execute computer-executable instructions stored on a computer-readable medium.

Software may be stored within memory 415 and/or storage to provide instructions to processor 403 for enabling device linking computing device 401 to perform various functions as discussed herein. For example, memory 415 may store software used by device linking computing device 401, such as operating system 417, application programs 419, and associated database 421. Also, some or all of the computer executable instructions for device linking computing device 401 may be embodied in hardware or firmware. Although not shown, RAM 405 may include one or more applications representing the application data stored in RAM 405 while device linking computing device 401 is on and corresponding software applications (e.g., software tasks) are running on device linking computing device 401.

Communications module 409 may include a microphone, keypad, touch screen, and/or stylus through which a user of device linking computing device 401 may provide input, and may also include one or more of a speaker for providing audio output and a video display device for providing textual, audiovisual and/or graphical output. Computing system environment 400 may also include optical scanners (not shown).

Device linking computing device 401 may operate in a networked environment supporting connections to one or more remote computing devices, such as computing devices 441 and 451. Computing devices 441 and 451 may be personal computing devices or servers that include any or all of the elements described above relative to device linking computing device 401.

The network connections depicted in FIG. 4 may include Local Area Network (LAN) 425 and Wide Area Network (WAN) 429, as well as other networks. When used in a LAN networking environment, device linking computing device 401 may be connected to LAN 425 through a network interface or adapter in communications module 409. When used in a WAN networking environment, device linking computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive customer device linking data, the customer device linking data including data linking one or more user computing devices to one or more payment devices, wherein linking the one or more user computing devices to the one or more payment devices causes one or more rules limiting transaction processing for the one or more payment devices to execute;
receive, from an entity computing device, a request to process a transaction, the request to process the transaction including transaction details including at least a payment device for processing the transaction and a unique identifier of a user computing device from which the request to process the transaction was received by the entity computing device;
analyze the received request to process the transaction and the transaction details to determine whether the payment device is linked to the user computing device;
responsive to determining that the payment device is linked to the user computing device, authenticate a user requesting the transaction and authorize the request to process the transaction; and
responsive to determining that the payment device is not linked to the user computing device:
generate a request for authentication data; and
transmit the request for authentication data to the user computing device, wherein transmitting the request for authentication data includes causing the request to display on a display of the user computing device.

2. The computing platform of claim 1, wherein the user computing device is a mobile device of the user.

3. The computing platform of claim 1, wherein the transaction is an online transaction initiated by the user computing device.

4. The computing platform of claim 1, wherein the one or more rules limiting transaction processing for the one or more payment devices include automatically authenticating the user requesting the transaction and authorizing the request to process the transaction based on the linking and without additional user input.

5. The computing platform of claim 1, wherein responsive to determining that the payment device is linked to the user computing device, authenticating a user requesting the transaction and authorizing the request to process the transaction further includes generating a transaction authorization instruction and transmitting the transaction authorization instruction to the entity computing device for execution.

6. The computing platform of claim 1, wherein responsive to determining that the payment device is linked to the user computing device, authenticating a user requesting the transaction and authorizing the request to process the transaction further includes generating a transaction authorization instruction and transmitting the transaction authorization instruction to a payment processing entity computing system.

7. The computing platform of claim 1, wherein the customer device linking data further includes registration data including authentication data of the user.

8. A method, comprising:
receiving, by a computing platform, the computing platform having at least one processor and memory, customer device linking data, the customer device linking data including data linking one or more user computing devices to one or more payment devices, wherein linking the one or more user computing devices to the one or more payment devices causes one or more rules limiting transaction processing for the one or more payment devices to execute;
receiving, by the at least one processor and from an entity computing device, a request to process a transaction, the request to process the transaction including transaction details including at least a payment device for processing the transaction and a unique identifier of a user computing device from which the request to process the transaction was received by the entity computing device;
analyzing, by the at least one processor, the received request to process the transaction and the transaction details to determine whether the payment device is linked to the user computing device;
responsive to determining that the payment device is linked to the user computing device, authenticating, by the at least one processor, a user requesting the transaction and authorizing the request to process the transaction; and
responsive to determining that the payment device is not linked to the user computing device:
generating, by the at least one processor, a request for authentication data; and
transmitting, by the at least one processor, the request for authentication data to the user computing device, wherein transmitting the request for authentication data includes causing the request to display on a display of the user computing device.

9. The method of claim 8, wherein the user computing device is a mobile device of the user.

10. The method of claim 8, wherein the transaction is an online transaction initiated by the user computing device.

11. The method of claim 8, wherein the one or more rules limiting transaction processing for the one or more payment devices include automatically authenticating the user requesting the transaction and authorizing the request to process the transaction based on the linking and without additional user input.

12. The method of claim 8, wherein responsive to determining that the payment device is linked to the user computing device, authenticating a user requesting the transaction and authorizing the request to process the transaction further includes generating a transaction authorization instruction and transmitting the transaction authorization instruction to the entity computing device for execution.

13. The method of claim 8, wherein responsive to determining that the payment device is linked to the user computing device, authenticating a user requesting the transaction and authorizing the request to process the transaction further includes generating a transaction authorization instruction and transmitting the transaction authorization instruction to a payment processing entity computing system.

14. The method of claim 8, wherein the customer device linking data further includes registration data including authentication data of the user.

15. One or more non-transitory computer-readable media storing instructions that, when executed by a computing platform comprising at least one processor, memory, and a communication interface, cause the computing platform to:
receive customer device linking data, the customer device linking data including data linking one or more user computing devices to one or more payment devices, wherein linking the one or more user computing devices to the one or more payment devices causes one or more rules limiting transaction processing for the one or more payment devices to execute;
receive, from an entity computing device, a request to process a transaction, the request to process the transaction including transaction details including at least a payment device for processing the transaction and a unique identifier of a user computing device from which the request to process the transaction was received by the entity computing device;
analyze the received request to process the transaction and the transaction details to determine whether the payment device is linked to the user computing device;
responsive to determining that the payment device is linked to the user computing device, authenticate a user requesting the transaction and authorize the request to process the transaction; and
responsive to determining that the payment device is not linked to the user computing device:
generate a request for authentication data; and
transmit the request for authentication data to the user computing device, wherein transmitting the request for authentication data includes causing the request to display on a display of the user computing device.

16. The one or more non-transitory computer-readable media of claim 15, wherein the user computing device is a mobile device of the user.

17. The one or more non-transitory computer-readable media of claim 15, wherein the transaction is an online transaction initiated by the user computing device.

18. The one or more non-transitory computer-readable media of claim 15, wherein the one or more rules limiting transaction processing for the one or more payment devices include automatically authenticating the user requesting the transaction and authorizing the request to process the transaction based on the linking and without additional user input.

19. The one or more non-transitory computer-readable media of claim 15, wherein responsive to determining that the payment device is linked to the user computing device, authenticating a user requesting the transaction and authorizing the request to process the transaction further includes generating a transaction authorization instruction and transmitting the transaction authorization instruction to the entity computing device for execution.

20. The one or more non-transitory computer-readable media of claim 15, wherein responsive to determining that the payment device is linked to the user computing device, authenticating a user requesting the transaction and authorizing the request to process the transaction further includes generating a transaction authorization instruction and transmitting the transaction authorization instruction to a payment processing entity computing system.

21. The one or more non-transitory computer-readable media of claim 15, wherein the customer device linking data further includes registration data including authentication data of the user.
